(19) United States
(12) Patent Application Publication
(10) Pub. No.: US 2023/0195975 A1
(43) Pub. Date: Jun. 22, 2023

(54) METHOD AND ELECTRONIC DEVICE FOR PERFORMING IMPERFECT EMULATION OF STATE OF MODEL

(71) Applicant: Srinivas Bharadwaj, Los Altos, CA (US)

(72) Inventor: Srinivas Bharadwaj, Los Altos, CA (US)

(21) Appl. No.: 17/938,416

(22) Filed: Oct. 6, 2022

Related U.S. Application Data
(63) Continuation-in-part of application No. 15/346,691, filed on Nov. 8, 2016, now abandoned.

(51) Int. Cl. G06F 30/27; G06N 3/044

(52) U.S. Cl. CPC G06F 30/27; G06N 3/044

(57) ABSTRACT

Present disclosure provides a method and an electronic device for performing imperfect emulation of a state of a model in an electronic device. The method includes determining, by an electronic device, a current state of at least one actual model of the electronic device and comparing, by the electronic device, the current state of the at least one actual model with at least one state of a reference model. The method also includes determining, by the electronic device, a target state to be achieved by the at least one actual model based on the at least one state of the reference model; determining, by the electronic device, a deviation of the current state of the at least one actual model with respect to the target state to be achieved by the actual model; and modifying, by the electronic device, the current state of the at least one actual model to emulate the target state to be achieved by the at least one actual model based on the at least one state of the reference model.

### TECHNICAL FIELD

The present disclosure relates to a cloud computing, and more particularly to a method and an electronic device for performing imperfect emulation of a state of a model in the electronic device.

### BACKGROUND

In general, emulation classifications can be multifold, notably there can be exact emulation or inexact emulation. Exact emulation happens when both the original and the secondary receive the same inputs and both the original and the secondary represent the same software. But sometimes, the original can also be based on a real world system, like an internal combustion engine or a human heart while the model can be a piece of software what emulates the same. When there is such an inexact emulation there can also be multifold goals of the overall process of emulation in the solution of real world problems. These can involve modelling, control, convergence of model and actual, and a variety of other goals tied to these goals or orthogonal to these goals. These orthogonal goals also can be meta-data driven and answer questions like, “Is the data helping us sufficiently enough so that there is convergence possible between the reference and the model?”. Supervision is the process that is used to ascertain this question. Supervision expands the goals of the process to include “learning” from the process beyond just learning from the model, where inputs and outputs from the real world are fed to the reference model and aim to help the model emulate the process the actual model follows. The “learning algorithm” then should be able to produce a close to real or reasonable solution to an unseen input that is also possible. A loss function defines the difference between actual and emulation or referentially modelled values. Minimization of this loss function using Empirical or Structural minimization methods is often the form that Supervision takes. An alternative to Supervision is Reinforcement learning which emphasizes reward maximization where reward could be an alternate goal and the decision made is to transition internal hidden state from S to S′ in such a way that the reward increases across a variety of scenarios. Neural networks today model offer the methodologies that help solve complex problems that were previously considered unsolvable.

Many forms of Neural Networks Training exist today. But mostly three models are popular. They are
1. Unsupervised Learning
2. Supervised Learning
3. Reinforcement Learning

Each of these methods allow for a way for the addition of new data to custom train a new Learning network such as a Recurrent Neural Network, a Neural Network with Backpropagation and a Neural network with backpropagation through time. These networks also can be used as systems that perform emulation. When a recorded set of inputs represent a set of states, these states can then be passed from a primary to an emulating device according to Patent Application . Now a Neural network also aims to emulate an unknown systems whose inner parameters are not properly understood. Thus, it is desired to provide a useful alternative.

### SUMMARY

The present disclosure provides a method for performing imperfect emulation of a state of a model in an electronic device, wherein the method includes determining, by an electronic device, a current state of at least one actual model of the electronic device and comparing, by the electronic device, the current state of the at least one actual model with at least one state of a reference model. The method also includes determining, by the electronic device, a target state to be achieved by the at least one actual model based on the at least one state of the reference model; determining, by the electronic device, a deviation of the current state of the at least one actual model with respect to the target state to be achieved by the actual model; and modifying, by the electronic device, the current state of the at least one actual model to emulate the target state to be achieved by the at least one actual model based on the at least one state of the reference model.

In an embodiment, the at least one actual model and the reference model comprises neural networks for performing imperfect emulations and wherein the at least one actual model and the reference model converge to perform the imperfect emulations.

In an embodiment, the reference model is trained using one of a sensory data set and a training data set.

In an embodiment, the comparing, by the electronic device, the current state of the at least one actual model with the at least one state of the reference model includes providing, by the electronic device, an input to the reference model, wherein the input to the reference model is same an input to the at least one actual model in the current state. The method also includes determining, by the electronic device, a weight of an output of the reference model for the provided input and a weight of an output of the at least one actual model in the current state; and comparing, by the electronic device, the current state of the at least one actual model with the at least one state of the reference model based on the weight of the output of the reference model and the weight of the output of the at least one actual model in the current state.

In an embodiment, modifying the current state of the at least one actual model to emulate the target state to be achieved by the at least one actual model minimizes an error between the current state of the at least one actual model and the target state to be achieved by the at least one actual model.

In an embodiment, the method further includes determining, by the electronic device, an improvement in at least one set of parameters of a plurality of set of parameters associated with an actual model of a plurality of actual models based on reward, wherein the reward is determined using a reinforcement learning technique, wherein the actual model is an alternate model newly introduced and the plurality of models are existing models; and emulating, by the electronic device, the at least one set of parameters of the plurality of set of parameters associated with remaining actual models of the plurality of actual models based on the improvement in the at least one set of parameters of the actual model.

In an embodiment, the at least one set of parameters of the plurality of set of parameters is shared between the plurality of actual models by a publish-subscribe (Pub-Sub) parameter sharing service and wherein the plurality of actual models is a set of parallel models.

In an embodiment, the target state of the at least one actual model is emulated to the current state of the at least one actual model by copying the plurality of set of parameters of a neural network of the reference model.

Accordingly the embodiments herein provide an electronic device for performing imperfect emulation of a state of a model. The electronic device includes a memory, a processor, a communicator and an emulation management controller. The emulation management controller is configured to determine a current state of at least one actual model of the electronic device and compare the current state of the at least one actual model with at least one state of a reference model. The emulation management controller is also configured to determine a target state to be achieved by the at least one actual model based on the at least one state of the reference model, determine a deviation of the current state of the at least one actual model with respect to the target state to be achieved by the actual model; and modify the current state of the at least one actual model to emulate the target state to be achieved by the at least one actual model based on the at least one state of the reference model.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 is an electronic device for performing imperfect emulation of a state of a model, according to the embodiments as disclosed herein;

FIG. 2 is an example Recurrent Neural Network (RNN) Model, according to the embodiments as disclosed herein;

FIG. 3 is a state representation of a recurrence formula for the RNN, according to the embodiments as disclosed herein;

FIG. 4 is a rrepresentation of a Recurrent Neuron, according to the embodiments as disclosed herein;

FIG. 5 illustrates a model for a Model Reference Adaptive System (MRAS), according to the embodiments as disclosed herein;

FIG. 6 illustrates a another version of the MRAS, according to the embodiments as disclosed herein;

FIG. 7 illustrates a Closed Loop Transfer, according to the embodiments as disclosed herein;

FIG. 8 is an example illustrating emulation of a state between an environment and a secondary device, according to the embodiments as disclosed herein;

FIG. 9 is an example illustrating parallel ensembles and incremental parametric improvements via a shared pub-sub channel in a plurality of actual models, according to the embodiments as disclosed herein;

FIG. 10 is an example illustrating introduction of a new actual model is in the plurality of actual models of the electronic device, according to the embodiments as disclosed herein;

FIGS. 11-12 illustrates clearing house of transfer learning services by the electronic device, according to the embodiments as disclosed herein; and

FIG. 13 is a flow chart illustrating a method for performing imperfect emulation of a state of a model, according to the embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to describing the present embodiment detail, it is useful to provide definitions for key terms and concepts used herein. Unless defined otherwise, all technical and scientific terms used herein have the same meaning as commonly understood by one of ordinary skill in the art.

The present disclosure provides a method for performing imperfect emulation of a state of a model in an electronic device, wherein the method includes determining, by an electronic device, a current state of at least one actual model of the electronic device and comparing, by the electronic device, the current state of the at least one actual model with at least one state of a reference model. The method also includes determining, by the electronic device, a target state to be achieved by the at least one actual model based on the at least one state of the reference model; determining, by the electronic device, a deviation of the current state of the at least one actual model with respect to the target state to be achieved by the actual model; and modifying, by the electronic device, the current state of the at least one actual model to emulate the target state to be achieved by the at least one actual model based on the at least one state of the reference model.

Accordingly the embodiments herein provide an electronic device for performing imperfect emulation of a state of a model. The electronic device includes a memory, a processor, a communicator and an emulation management controller. The emulation management controller is configured to determine a current state of at least one actual model of the electronic device and compare the current state of the at least one actual model with at least one state of a reference model. The emulation management controller is also configured to determine a target state to be achieved by the at least one actual model based on the at least one state of the reference model, determine a deviation of the current state of the at least one actual model with respect to the target state to be achieved by the actual model; and modify the current state of the at least one actual model to emulate the target state to be achieved by the at least one actual model based on the at least one state of the reference model.

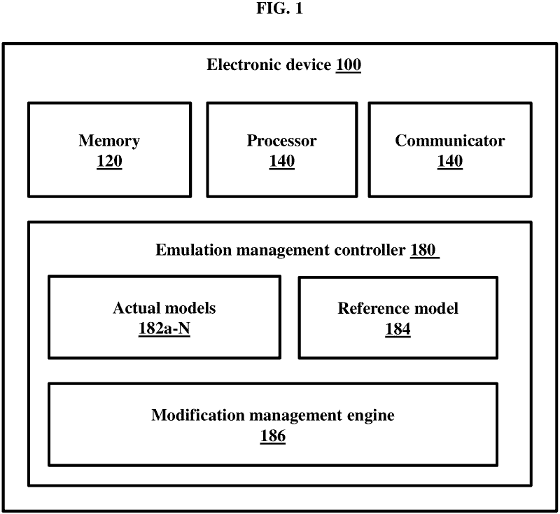

Referring now to the drawings, and more particularly to FIGS. 1 through 13, where similar reference characters denote corresponding features consistently throughout the figures, there are shown preferred embodiments.

FIG. 1 is an electronic device (100) for performing imperfect emulation of a state of a model, according to the embodiments as disclosed herein. Referring to the FIG. 1, the electronic device (100) may be but not limited to a laptop, a palmtop, a desktop, a mobile phone, a smart phone, Personal Digital Assistant (PDA), a tablet, a wearable device, an Internet of Things (IoT) device, a virtual reality device, a foldable device, a flexible device, a display device and an immersive system.

In an embodiment, the electronic device (100) includes a memory (120), a processor (140), a communicator (160) and an emulation management controller (180).

The memory (120) is configured to store instructions to be executed by the processor (140). The memory (120) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) is configured to store larger amounts of information. In certain examples, a non-transitory storage medium may store data that can, over time, change (e.g., in Random Access Memory (RAM) or cache).

The processor (140) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (140) may include multiple cores and is configured to execute the instructions stored in the memory (120).

In an embodiment, the communicator (160) includes an electronic circuit specific to a standard that enables wired or wireless communication. The communicator (160) is configured to communicate internally between internal hardware components of the electronic device (100) and with external devices via one or more networks.

In an embodiment, the emulation management controller (180) includes actual models (182a-N), a reference model (184) and a modification management engine (186).

In an embodiment, the actual models (182a-N) are made of neural networks and include multiple states of an application.

In an embodiment, the reference model (184) indicates ideal states of an application at any instant of time.

In an embodiment, the modification management engine (186) is configured to determine a current state of the actual model (182a) of the electronic device (100). The modification management engine (186) is configured to provide an input to the reference model (184). The input to the reference model is same an input to the at least one actual model in the current state. Further, the modification management engine (186) is configured to determine a weight of an output of the reference model (184) for the provided input and a weight of an output of the at least one actual model (182a) in the current state; and compare the current state of the at least one actual model (182a) with the at least one state of the reference model (184) based on the weight of the output of the reference model (184) and the weight of the output of the at least one actual model (182a) in the current state.

The modification management engine (186) is configured to determine a target state to be achieved by the at least one actual model (182a) based on the at least one state of the reference model (184), determine a deviation of the current state of the at least one actual model with respect to the target state to be achieved by the actual models (182a-N); and modify the current state of the at least one actual models (182a) to emulate the target state to be achieved by the at least one actual model (182a) based on the at least one state of the reference model (184). Modifying the current state of the at least one actual model to emulate the target state to be achieved by the at least one actual model (182a) minimizes an error between the current state of the at least one actual model (182a) and the target state to be achieved by the at least one actual model (182a).

The at least one actual model and the reference model (184) includes neural networks for performing imperfect emulations and where the at least one actual model and the reference model (184) converge to perform the imperfect emulations. The reference model (184) is trained using one of a sensory data set and a training data set.

The modification management engine (186) is also configured to determine an improvement in at least one set of parameters of a plurality of set of parameters associated with the actual model (182a) of a plurality of actual models (182aN) based on reward. The reward is determined using a reinforcement learning technique, where the actual model (182a) is an alternate model newly introduced and the plurality of models are existing models; and emulate the at least one set of parameters of the plurality of set of parameters associated with remaining actual models of the plurality of actual models based on the improvement in the at least one set of parameters of the actual model (182a).

The at least one set of parameters of the plurality of set of parameters is shared between the plurality of actual models (182a-N) by a publish-subscribe (Pub-Sub) parameter sharing service and wherein the plurality of actual models is a set of parallel models.

The target state of the at least one actual model (182a) is emulated to the current state of the at least one actual model (182a) by copying the plurality of set of parameters of a neural network of the reference model (184).

The emulation management controller (180) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

At least one of the plurality of modules/ components of the emulation management controller (180) may be implemented through an AI model. A function associated with the AI model may be performed through memory (120) and the processor (140). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 1 show the hardware elements of the electronic device (100) but it is to be understood that other embodiments are not limited thereon. In other embodiments, the electronic device (100) may include less or more number of elements. Further, the labels or names of the elements are used only for illustrative purpose and does not limit the scope of the invention. One or more components can be combined together to perform same or substantially similar function.

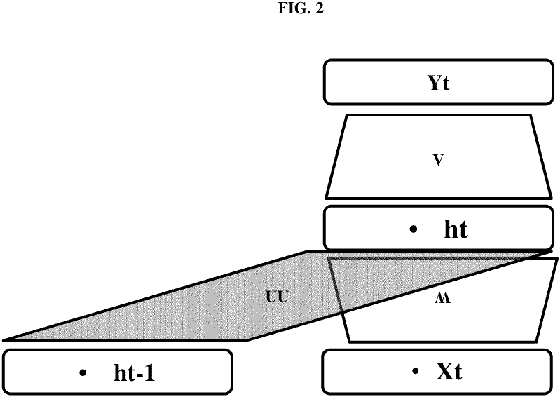

FIG. 2 is an example Recurrent Neural Network (RNN) Model, according to the embodiments as disclosed herein.

Referring to the FIG. 2, the RNN Model is represented using the equations below:

$$\text{ht = f} \left(\text{Uht-1+WXt}\right)$$

$$\text{Yt = Vht}$$

Xt == input at t, Yt == output at t, Ht - state of hidden weights at time t and Ht-1 - state of hidden weights at time t-1.

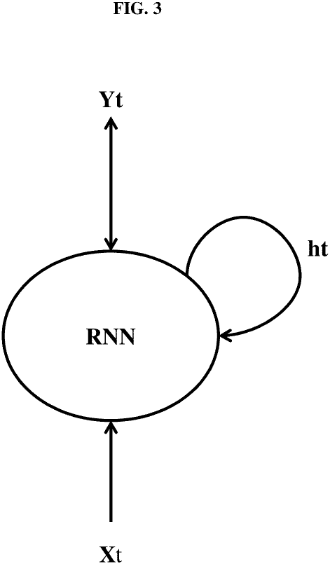

FIG. 3 is a state representation of a recurrence formula for the recurrent neural network (RNN), according to the embodiments as disclosed herein.

Referring to the FIG. 3, the state representation of the recurrence formula for the RNN is provided below:

With additional Input Xt at each step we produce a new Yt

$$\text{ht} \text{=} \text{f} \left(\text{ht-1*Xt}\right)$$

Ht-1 is the old state of the RNN an d Ht is the new state of the RNN

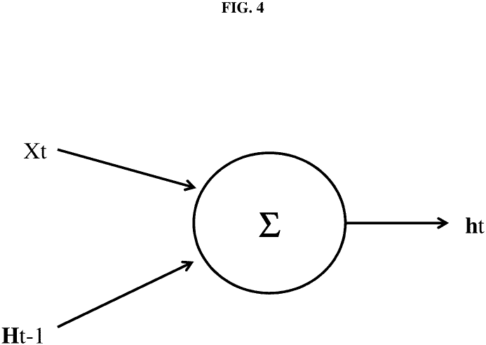

FIG. 4 is a representation of a Recurrent Neuron, according to the embodiments as disclosed herein.

Referring to the FIG. 4, the recurrent neuron is represented as below:

$$\text{ht = f} \left(\text{Uht-1 + WXt}\right)$$

Xt is input at time t, Ht is state of neuron at time t, Ht-1 is the state at time t-1, W is the Weights and U is the hidden Weights.

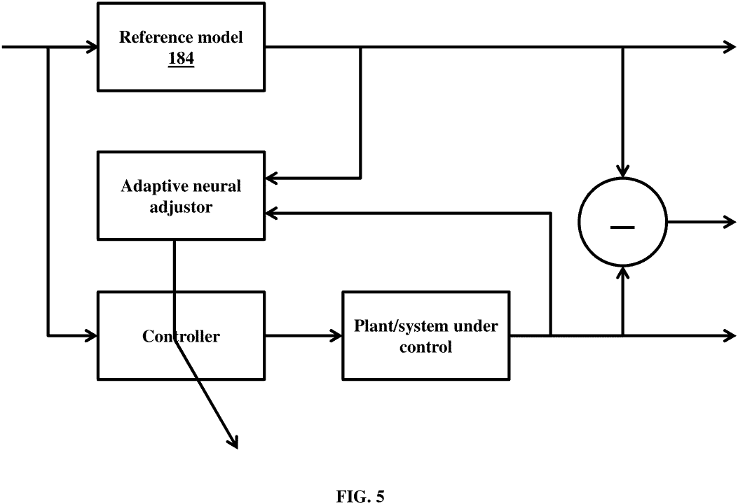

FIG. 5 illustrates a model for a Model Reference Adaptive System (MRAS), according to the embodiments as disclosed herein.

Referring to the FIG. 5, before the origins of Neural Computing, Adaptive Control systems performed much the same kind of operations albeit working with less complicated systems. The FIG. 5 describes the model for an MRAS or Model Reference Adaptive System.

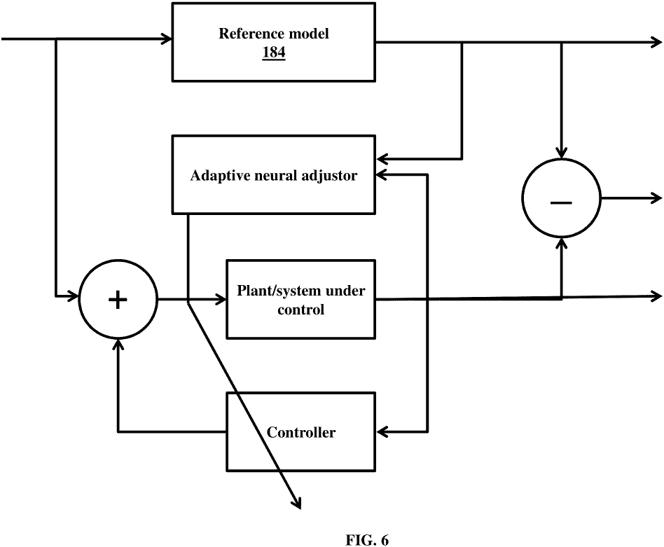

FIG. 6 illustrates the version of the MRAS, according to the embodiments as disclosed herein.

The Reference Model receives the same input and produces the necessary output Y_{RM} which is then weighed against the “Controlled” output of the plant. The adjustor adjusts the controller, which then alters the total response of the Plant under control Y_{AC} and aims to minimize the error or difference between YRM and Y_{AC}. There are two distinct perspectives here that reflect the aim of setting up the Controlled Systems and the observation. One perspective aims to make a more real Reference Model that fully mimics the Controlled Plant. The second aims to build a case for a more sophisticated Controller that closely mimics an ideal Reference Model. For example, if the plant were a Thermal Power Plant, the Reference model may reflect a higher efficiency model like say an ultra-critical 35% efficiency Thermal Power Plant. The first case would look to have the Reference Model closely track what is possible with the Plant. The second perspective would look to alter the controller (by say altering the burning rates or the mix of fuels or other secondary factors like Pressure, Volume and steam temperature) in such a way that the Plant more closely parallels the efficiency of the Reference Model.

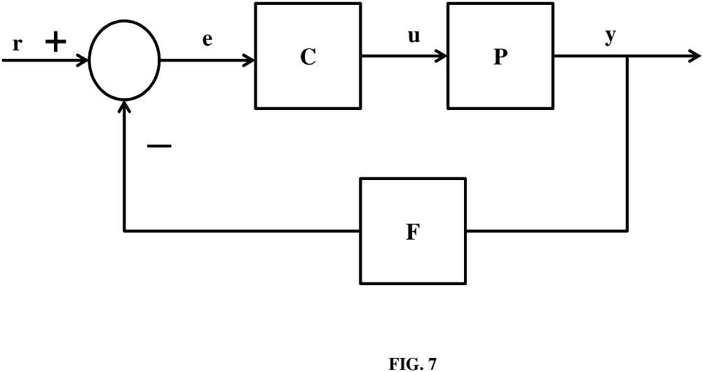

FIG. 7 illustrates a Closed Loop Transfer, according to the embodiments as disclosed herein.

Referring to the FIG. 7, the closed loop transfer is provided. The equations associated with the closed loop transfer are:

$$\text{Y} \left(\text{s}\right) = \text{P} \left(\text{s}\right) \text{U} \left(\text{s}\right)$$

$$\text{U} \left(\text{s}\right) = \text{E} \left(\text{s}\right) \text{C} \left(\text{s}\right)$$

$$\text{E} \left(\text{s}\right) = \text{R} \left(\text{s}\right) - \text{F} \left(\text{s}\right) \text{Y} \left(\text{s}\right)$$

$$\text{Y} \left(\text{s}\right) = \text{H} \left(\text{s}\right) \text{R} \left(\text{s}\right) \text{where H} \left(\text{s}\right) = \text{P} \left(\text{s}\right) \text{C} \left(\text{s}\right) / \left(1 + \text{F} \left(\text{s}\right) \text{P} \left(\text{s}\right) \text{C} \left(\text{s}\right)\right)$$

Equations (5) to (8) represent the traditional Feedback Loop Closed Loop Transfer function.

In an example, consider healthcare domain where there is a dichotomy of priorities with respect to the model and actuality. Models are developed to understand the actual under periods of no duress and healthy behavior or under periods of duress but with stress-induced changes that are normal. The Reference Model then forms the basis of how the reference system closely mimics the particular human’s system or body or organ. This could be a heart that is under the control of a pacemaker and the stressors could be walking in an elevation or where the air is thin due to a high altitude or times of emotional pressure as experienced by a veteran in a war zone. The second model is where the deviation from a reference model is used to change or affect the actual. Take for instance the case of continuous glucose monitoring where the reference model reflects a diabetic with a managed and regulated glucose or A1C level that is within acceptable norms for someone with such a condition. Assuming a deviation to a “very low glucose” level, this is aided by an intake of carbohydrates or a “very high glucose” level, which is handled with additional insulin. In this case, the actual system is being altered based on the difference from the Reference Model.

Perfect Emulation happens when every action on the original or primary or emulated system is replicated and seen by the secondary or emulating system. On top of this the secondary system is a mirror image of the primary system. If the primary system is a MySQL Database, and the secondary is also a MySQL Database or a similar relational database with identical tables, then the two systems are identical enough for perfect emulation. Typical systems use CRUD operations(Create, Read, Update and Delete) to make changes and Create, Update and Delete modify the system. These are usually recorded in a Transaction Log. If these operations(C,U,D) are replicated in the same order as on the original then one can achieve full emulation or full replication. Today data store replication is accomplished by replicating the transaction log. Containerization has been an added advantage as one can control the list of actions that take place to any container and replicate the actions in the same order.

UI based systems are also replicated by a similar action. If every user and external event that changes the system is replicated in order, and the software is the same, then the two systems will proceed in lock step. Ordering alone matters in many systems except when the software is dependent on the time intervals between actions(and timing does not). When it is independent of the time interval between actions, we can replay the events at a variable (accelerated or slower) rate when compared to the original.

The states reached by the two systems in perfect emulation are identical after an identical set of events are processed. What happens with two systems can also be extended easily to multiple systems by the use of the same primary secondary model.

Perfect Emulation with two or more primaries: Sometimes events and actions require more than one primary, and there is a combination of systems used. Horizontal scaling is a common principle in transaction processing and eCommerce. Many identical systems act as primaries. Sometimes these systems use one datastore or database. Sometimes there is a secondary standby system that can become the primary if the situation warrants. The simplest way is to replicate the transaction log on the one datastore on the standby. Log playback if it happens in order can be done concurrently. A full “Bulk Copy” can be done at certain intervals when the systems are briefly halted. Log playback on the other hand can happen concurrent with transaction processing.

When there are two (or more) primaries which are processing transactions actively possibly from multiple data centers, then too, it is possible to replicate perfectly. Often geographical separation by itself ensures that the two sets of transactions are separated enough and all that is needed is for the two logs to be concurrently played on each other.

For Horizontal Scaling, on a single database, very often, two phase locking is employed to prevent deadlocking of systems. This methodology is very typical in the state of the art. Locks are obtained and if all locks are not obtained, all are released so that they can be reobtained at a later point when other competing systems are done and no longer busy with the same locks. This is done using a back-off algorithm. Horizontal Scaling can work with a single database or multiple non-colliding data sets. One example of a noncolliding dataset would be where user accounts from users who start with A-H and I-R and S-Z are on different datasets and requests are routed appropriately. Even a good hashing technique can divide the datasets and facilitate horizontal scaling. However dataset separation is not always feasible and rerouting may be more difficult. Further redundancy in the face of modular or collective group failure requires handling. In the earlier case, if the system dealing with A-H fails, and the data for A-H is also replicated in I-R, which in normal times is the secondary but does a takeover and then there is a return back to the original set after it recovers. These mechanisms are well-known and have existed since the days OLTP systems were first invented and fault tolerance was a key requirement. The concept of a transaction log also needs to be interpreted differently though. Change Data Capture (CDC) is the state of the art in handling synchronization and replication of changes in transaction processing systems including those that involve SQL and NoSQL databases. Today, “transaction log” is often replicated using a distributed event system like Kafka. This is in-fact only one of the mechanisms. One of the systems in the current state of the art is Debezium. (Another approach is offered by DataBus) It is possible to build a Trigger-based CDC or a Query-Based CDC as well. Strictly ordering is typically managed by the use of partition keys. Holistic, ordered and exactly once semantics can be implemented through Kafka and the correct management of offset committing semantics and using its inherent fault tolerance features. The primary could be Kafka Producer or group of producers which generate the log. The secondary could be a consumer group which consumes the log and updates its version of the same store.

A secondary optimization often used in today’s environment is CQRS or Command Query Responsibility Segregation. This design pattern separates searching as a dedicated subset of the overall service and is aimed at search optimization. This can lead to two clusters with horizontal scaling, one for READ and one for WRITE. The system allows for separate scaling and specialization. The WRITE side is heavily IO bound while the SEARCH side is heavily compute bound and the separation of specialization facilitates different adaptation for performance. With containerization, a subset of the servers are dedicated to READ only search queries. Sometimes with CQRS there are two separate datastores with the WRITE datastore sending updates to the READ datastore. The READ datastore is dedicated to the searchers. An added problem comes when there are Caches in the SEARCH or READ side. These caches have to stay in sync with the data on the WRITE side. An Event or Messaging Service like Kafka is used facilitate the update of the caches.

However sometimes there are multiple active primaries and data stores required for scaling and transactions are interdependent. What is needed is to ensure that when transactions collide, “global order” is maintained in a distributed setting. Order maintenance protocols, algorithms and practices can help tremendously here. Simple algorithms would have an order precedence algorithm which favors one system over the other in the event of a collision. So long as both systems keep the same order the result will be the same. Temporal order through “Synchronized clocks” or tracking clocks is one mechanism. Hence an absolute timestamp is used and regardless of actual clock skew order is maintained. When an absolute timestamp is not possible, Lamport Clocks or Lamport Timestamps are used which maintain logical time ordering for events and help in resolving such collisions. The typical assumption is that a send of information precedes the receipt of the same information. When there is a writer of a distributed log implemented possibly using a messaging queue or a pub-sub system like Kafka, the production of the message is said to precede the consumption of the same message. But when there are two queues or topics we can have a precedence order or convention with respect to time. This can provide the needed mechanism for facilitate partial ordering.

When collisions happen between transactions, it may occasionally be necessary to detect such a collision across the distributed logs and reverse one or the other and then replay both in the same order of occurrence.

Distributed Transactional requirements, namely ACID properties, which often involve requirements where some sets of transactions must be treated together and in an order and require an “in order all or none semantic” can be maintained by ensuring that they are dealt by one of the two or more primaries. The ordering of actions matters too in certain cases when it determines success or failure. One example is the case when watermarks (like margin requirements in financial systems) come into play in determining transaction success or failure. One possible way is to place a hold on the readability of the account value or sets of values, till each transaction completes and is committed. These are not easy to requirements to meet.

Perfect replication is still very complicated and may not happen and require human intervention and analytics in rare occasions to break collisions or gridlock if there are special failure conditions. To facilitate analytics and intervention, reversibility of every transaction is a useful requirement. Reversibility allows one to retrace and redo action from a synchronized checkpoint.

Catch UP Protocol and Methodology: CatchUp Mechanisms are used to facilitate the sync of a primary with a secondary while both are functioning. With CatchUp, a distributed event based log using a system such as Kafka. Kafka uses a monotonically increasing Offset per topic and the producer and consumer are simultaneously writing and reading the message queue on a topic.

CatchUp Protocol is implemented through a second topic rather than the distributed Log that transmits Transactions. The consumer indicates an intent to CatchUP with an “Intention” mention first.

The Producer sends a “CatchUp” message with an associated Offset that reflects a particular message in the distributed Log. It is then upto the Consumer to make a best effort at catching up with the producer by consuming messages as a faster rate than the producer. When it reaches the associated Offset, the Consumer sends a “Almost CaughtUp” message with the same Offset. At this point the Producer stops its actions and sends a “Pause” with an associated Offset. The Consumer then quickly reaches this Offset and then sends a “CaughtUp” message. From here on the Producer and Consumer proceed at “Lock Step”. If this is a transaction system, Lock Step is implemented by the Producer following a distributed two-phase commit that performs action on both systems or neither.

Halt and Handoff: With the two systems in Lock-Step, the next stage involves the primary halting the execution of transactions by sending a Halt Message and then sending a handoff message (with a final offset) to the secondary application thus allowing the secondary application to begin execution. The secondary application could begin with Lock-Step execution thus updating both systems or it can update its own databases or stores while adding data to the queue to facilitate a catch-up from the original primary or a third system that is a replacement. Handoff also can use the same message queues(or in Kafka, topics). The handoff message also includes the final offset. The Halt Message tells the secondary to be ready to take over the handoff. So between the Halt and the Handoff there has to be a takeover sent from the Secondary application to the Primary application .

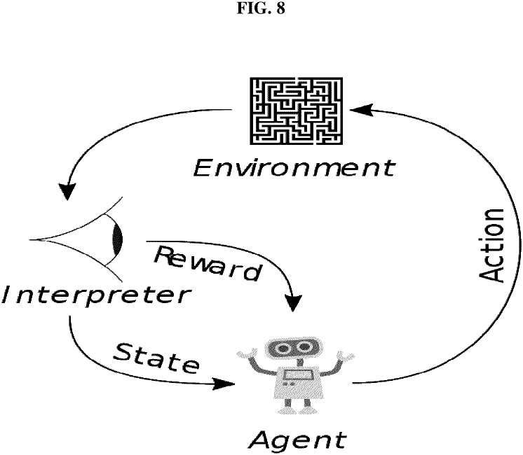

FIG. 8 is an example illustrating emulation of a state between an environment and a secondary device, according to the embodiments as disclosed herein.

When the processes are proceeding in lock step the sync points are setup which are periodic and which allow a lagging secondary electronic device (100b) to reach a consistent state and then go to the next consistent state. This helps reduce the time to handle “Catch-up” events. Here, the secondary electronic device (100b) may be just a secondary application running on the same electronic device (100).

Further, the separation of functions causes the two applications (primary and secondary running on the same electronic device (100)) to be working separately and specializing in the solution of different problems.

Furthermore, the replication of remote state is performed through at least one of a full snapshot of the application state and a distributed fork mechanism. One can snapshot a system that reaches a quiescent but ready state. And then restore it many times to then start up and begin execution. Containerization and Virtualization has exploited these mechanisms in the state of the art.

Currently, many transaction processing systems separate analytics applications as a separate service and use additional AI based applications to better sell and keep customers engaged and enhance customer relationship, service relationship, logistics etc. These multi-faceted needs imply that replication is unavoidable. Two sets of actions take place often. User clicks at the front end of the electronic device (100) which translates to accesses and interests which are transmitted to a back end which then uses these to understand user behavior and interest. The front end of the electronic device (100) to the End User is provided by the front-side App that handles transactions. This aims to keep the back end of the electronic device (100) updated using the various methodologies. But as the user navigates through invitations to related products are produced by navigating a catalog of products. Large Retailers can easily hold catalogs that involve 100,000 or more products or items that are actively inventoried. In such cases, as the user navigates, new items that correlate with the user’s prior or present interest or navigation history will start to appear. The process of transferring ongoing session relevant navigation is an important event in separation of functions by the electronic device (100). Both primary and secondary applications hold the session state as well as user history and the offers in front of him that the user clicked or avoided. This navigation of the user from one state to another is transmitted along with what else the user sees. The user’s graphical clicks will let the analytics Application guide the front side app in some cases.

In other applications, the user’s clicks will record the user reaction and look to ready a better model of the user offline so that a follow on session produces an optimized and better purchasing history. There can optionally be “reinforcement learning” (as indicated in the FIG. 8) that helps the analytics Application to record actions and provide suggestions and maximize a reward function which could be sales or user retention or clicks based on the reward goal. The primary application could be a standard eCommerce platform while the back end secondary could be an analytics application that works with the primary both by replicating its state as well as using past history in determining how best to maximize reward.

In the FIG. 8, the primary application is represented as the environment; the state is replicated between the environment and the secondary application which is the agent. The Agent proposes actions (for eCommerce that is what is to be displayed to the eCommerce application or platform user) that lead to the environment state changes and produce rewards that are fed back to the reinforcement learning system that is the agent.

Whether it is the actual system being modified or the model that is modified or a combination of both the model and the controlled actual system to meet the norms, processes used to handle inexact emulation that facilitate convergences between the two in the context of Neural Networks and Machine Learning can achieve better results than previous versions of the same. Forms of Imperfect emulation allow us to build ways by which both the reference and the actual converge. The reference could have begun its training from a prior set of data either sensory or training data. But it could then start to be trained first from a “good set of data”. Based on the goals of the management, the level to which the reference model will be trained or the actual will be altered through control is a key choice that could itself be defined or determined either prior to the period of training or using the algorithm. The imperfect emulation is the process through which systems adapt and intelligent convergence between the actual Model and the Reference model is achieved.

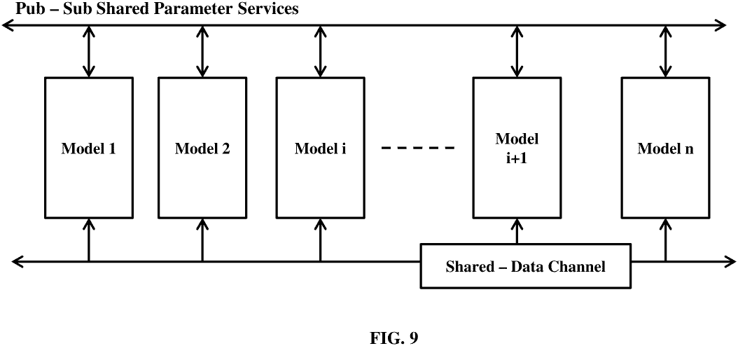

FIG. 9 is an example illustrating parallel ensembles and incremental parametric improvements via a shared pub-sub channel in a plurality of actual models, according to the embodiments as disclosed herein;

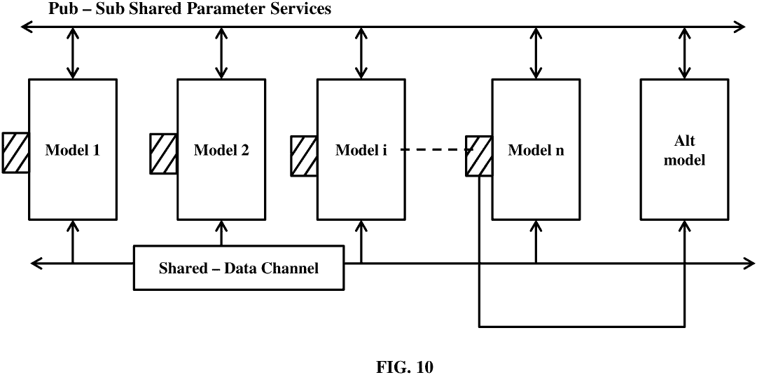

FIG. 10 is an example illustrating introduction of a new actual model is in the plurality of actual models of the electronic device, according to the embodiments as disclosed herein.

In some scenarios, there are multiple chains of action and a division of data streams. This could be due to different characteristics associated with say for example, patients. For example, the division of the data streams through say A1C among patients with Diabetes [A1C varies below 5.7% is normal, between 5.7 to 6.5% is considered preDiabetes, while a range over 6.5% is considered diabetes]. The aim can be to divide streams of the data based on this classification and build multiple different models in the electronic device (100). The electronic device (100) can use the ensemble techniques to evaluate the results of the classification based on the above criteria. When a large range of patients exist, it necessary to use one of two techniques - Bagging (Bootstrapping and Aggregation), Stacking or Random Forest Models.

When the electronic device (100) uses the imperfect emulation then the Bagging can be used. Stacking models involve essentially Perfect Emulation. Often the need in the AI is to process a large set of models and hence Perfect Emulation are important. The models can be trained a plurality of times or the state of a model can be replicated or a combination of both can be performed. In one example scenario, the process begins with a state replication of the model and then streams of training data are passed to further customize the models. Therefore, the ensemble techniques help in managing the data streams in various scenarios. The state replication of the model involves copying the parameters of the neural network by the electronic device (100). One example of the state replication is via a clone model in Tensor Flow --tf.keras.models.clone_model or using a Mirrored Strategy which supports synchronous distributed training on many different GPUs with one replica per GPU device. A variant of the same is the Mirrored MultiWorker Strategy.

A second strategy that Tensor Flow employs is using a Parameter server which is described as the state replication of the model as the data from the Parameter server can be provided to help establish the new models.

Referring to the FIG. 9, the parallel ensembles and the incremental parametric improvements via the shared pub-sub channel is provided. A set of parallel models that Pub-Sub parameter sharing service is provided in the FIG. 9. The shared data channel passes data through the multiple models, sometimes with differing data sets and sometimes with staggered bagging based ensembles as well as boosting based ensembles. Continuously, the performance of the models is measured and when an improvement in the performance is determined then the performance is instantaneously measured. When there is a substantial improvement (as defined by reward in the reinforcement learning context) then all the models absorb the parameters (or more specifically the changed parameters). With the perfect model emulation, the models have all the same set of parameters and then make changes searching for the next optimum. With the imperfect emulation, each model maintains a unique set of parameters and then adjusts one subset of the parameters based on an improvement in one of the models to the data set. This is different from the reinforcement learning and a way to use the imperfect emulation as a “distributed Ensemble Techniques” to achieve distributed model optimization. Existing art describes, combining ensemble techniques in data handling and management. However combining both the ensemble techniques in the data handling and the management along with the distributed model optimization and sharing the data through the pub-sub models with a view to faster convergence needs to be further worked on.

Referring to the FIG. 10, a scenario where a new model (referred to as Alt model in the FIG. 10) is introduced into the parallel ensembles. Further, plurality of model based platforms continue to target services that are distributed and the imperfect emulation is used when adding the new models that are substantially different such as for example but not limited to: addition of the layers to the neural network and addition of the parameters (and are built to enhance or improve the “Reward” as provided in the reinforcement learning techniques). The imperfect emulation sometimes may require proceeding with replay of the data sequences which might follow a record of consumed data from a data set and the record of the consumed data is also maintained by the electronic device (100). When there is improvement with the Alt Model, then the existing models can replicate the newer Alt Model. Or the Alt Model can transition in a more gradual manner where there are both models in the ensemble. These multi-model distributed ensemble platforms often involve varying drift of the parameters with a view to find better results with respect to the “Reward” faster. These scenarios facilitate improvements using the distributed ensemble techniques where the imperfect emulation makes the solutions better. The new “distributed ensemble” models can maximize the reward across a range replicated services involving many datasets.

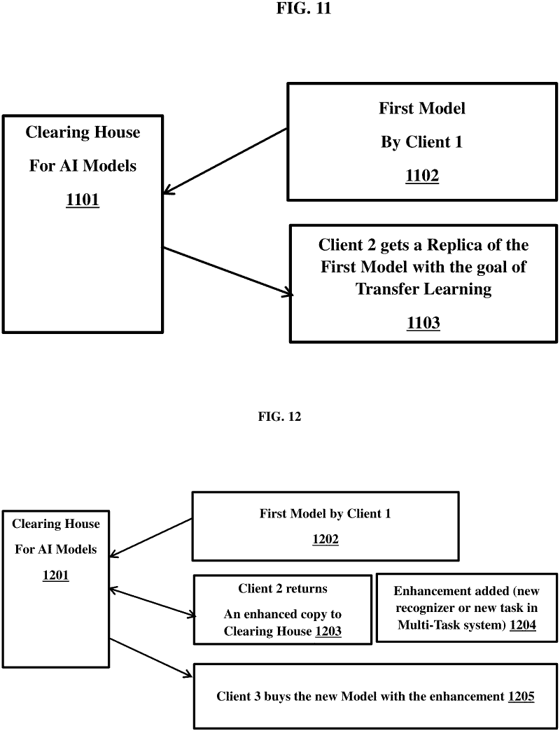

FIGS. 11-12 illustrates clearing house of transfer learning services by the electronic device, according to the embodiments as disclosed herein.

Transfer learning and ensemble delivery services: In general, prior art in AI Replication involves techniques associated with the transfer learning which includes a transfer of parameters (like Weights) from a given Model to a related model that works on a slightly different data set. Also, an inductive transfer of the parameters involves the free transfer of learning and works when there is no Model Bias.

In assessing “imperfect replication or emulation”, the transfer could be from one Ensemble to another or a progressive improvement to a new Ensemble. The transfer learning takes advantage of one model which has “learnt” by adapting to a first setting and extracting detailed information from that setting and then using that adaptation in a different setting. With the imperfect replication, the electronic device (100) can have an expansion of the number of layers in the new model vis-a-vis the old model and the use of Reinforcement Learning to improve the “Reward”. With Ensemble techniques the electronic device (100) can have two models, one a closer copy to the original that is working on the new data and the other a bigger model with more layers (or lesser layers) that then trains and looks to improve the discovery.

Layer growth and transfer learning as a service: The prior art facilitates using the transfer learning along with the layer growth to solve adjacent problems to a given solved problem by the electronic device (100). For example, if the model in the electronic device (100) is trained to detect sperm whales then the model can also be retrained to detect Orcas (Killer Whales) by the electronic device (100). The service in the electronic device (100) can provide the model on one whale and this can be used by a buyer of the service to train the model on a different whale. This second model can then be fed back into the Service by the electronic device (100). Therefore, the clearing house of transfer learning services is provided by the electronic device (100). A secondary electronic device (100) could be that of augmentation for which the service is enhanced with either a parallel system or by adding additional layers to the original so the secondary electronic device (100) adds and augments the model. The electronic device (100) with multi task learning can add to the number of tasks learnt. So a new client of the service adds an additional task and then returns it back to the service which functions as the clearing house. The proposed methodology can be used to produce public services. These Cloud based services are available as a “Model as a Service” platform.

Referring to the FIG. 11, at step 1101, the clearing house for AI models is provided and at step 1102, the first model is provided by the client 1. At step 1103, the client 2 gets a replica of the first model provided by the client 1, with the goal of transfer learning. Similarly, referring to the FIG. 12, at step 1102, the clearing house for the AI models is provided and at step 1202, the first model is provided by the client 1. At step 1203, the client 2 returns an enhanced copy to the clearing house and at 1204, enhancement is added (new recognizer or new task in Multi-Task system). At step 1205, the client 3 buys the new model with the enhancement.

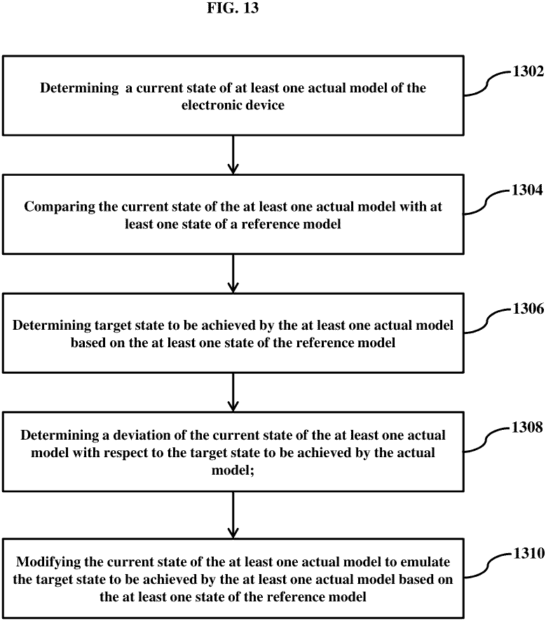

FIG. 13 is a flow chart illustrating a method for performing imperfect emulation of a state of a model, according to the embodiments as disclosed herein.

Referring to the FIG. 13, at step 1302, the method includes the electronic device (100) determining a current state of at least one actual model of the electronic device (100).

At step 1304, the method includes the electronic device (100) comparing the current state of the at least one actual model with at least one state of a reference model.

At step 1306, the method includes the electronic device (100) determining target state to be achieved by the at least one actual model based on the at least one state of the reference model.

At step 1308, the method includes the electronic device (100) determining a deviation of the current state of the at least one actual model with respect to the target state to be achieved by the actual model.

At step 1310, the method includes the electronic device (100) modifying the current state of the at least one actual model to emulate the target state to be achieved by the at least one actual model based on the at least one state of the reference model.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the claims as described herein.

What is claimed is:

1. A method for performing imperfect emulation of a state of a model in an electronic device (100), wherein the method comprising:
determining, by an electronic device (100), a current state of at least one actual model of the electronic device (100);
comparing, by the electronic device (100), the current state of the at least one actual model with at least one state of a reference model;
determining, by the electronic device (100), a target state to be achieved by the at least one actual model based on the at least one state of the reference model;
determining, by the electronic device (100), a deviation of the current state of the at least one actual model with respect to the target state to be achieved by the actual model; and
modifying, by the electronic device (100), the current state of the at least one actual model to emulate the target state to be achieved by the at least one actual model based on the at least one state of the reference model.

2. The method as claimed in claim 1, wherein the at least one actual model and the reference model comprises neural networks for performing imperfect emulations and wherein the at least one actual model and the reference model converge to perform the imperfect emulations.

3. The method as claimed in claim 1, wherein the reference model is trained using one of a sensory data set and a training data set.

4. The method as claimed in claim 1, wherein comparing, by the electronic device (100), the current state of the at least one actual model with the at least one state of the reference model comprises:
providing, by the electronic device (100), an input to the reference model, wherein the input to the reference model is same an input to the at least one actual model in the current state;
determining, by the electronic device (100), a weight of an output of the reference model for the provided input and a weight of an output of the at least one actual model in the current state; and
comparing, by the electronic device (100), the current state of the at least one actual model with the at least one state of the reference model based on the weight of the output of the reference model and the weight of the output of the at least one actual model in the current state.

5. The method as claimed in claim 1, wherein modifying the current state of the at least one actual model to emulate the target state to be achieved by the at least one actual model minimizes an error between the current state of the at least one actual model and the target state to be achieved by the at least one actual model.

6. The method as claimed in claim 1, further comprising:
determining, by the electronic device (100), an improvement in at least one set of parameters of a plurality of set of parameters associated with an actual model of a plurality of actual models based on reward, wherein the reward is determined using a reinforcement learning technique, wherein the actual model is an alternate model newly introduced and the plurality of models are existing models; and
emulating, by the electronic device (100), the at least one set of parameters of the plurality of set of parameters associated with remaining actual models of the plurality of actual models based on the improvement in the at least one set of parameters of the actual model.

7. The method as claimed in claim 6, wherein the at least one set of parameters of the plurality of set of parameters is shared between the plurality of actual models by a publish-subscribe (Pub-Sub) parameter sharing service and wherein the plurality of actual models is a set of parallel models.

8. The method as claimed in claim 1, wherein the target state of the at least one actual model is emulated to the current state of the at least one actual model by copying the plurality of set of parameters of a neural network of the reference model.

9. An electronic device (100) for performing imperfect emulation of a state of a model, wherein the electronic device (100) comprises:
a memory (120);
a processor (140) coupled to the memory (120);
a communicator (160) coupled to the memory (120) and the processor (140);
an emulation management controller (180) coupled to the memory (120), the processor (140) and the communicator (160), and configured to:
determine a current state of at least one actual model of the electronic device (100);
compare the current state of the at least one actual model with at least one state of a reference model;
determine a target state to be achieved by the at least one actual model based on the at least one state of the reference model;
determine a deviation of the current state of the at least one actual model with respect to the target state to be achieved by the actual model; and
modify the current state of the at least one actual model to emulate the target state to be achieved by the at least one actual model based on the at least one state of the reference model.

10. The electronic device (100) as claimed in claim 9, wherein the at least one actual model and the reference model comprises neural networks for performing imperfect emulations and wherein the at least one actual model and the reference model converge to perform the imperfect emulations.

11. The electronic device (100) as claimed in claim 9, wherein the reference model is trained using one of a sensory data set and a training data set.

12. The electronic device (100) as claimed in claim 9, wherein the emulation management controller (180) is configured to compare the current state of the at least one actual model with the at least one state of the reference model comprises:
provide an input to the reference model, wherein the input to the reference model is same an input to the at least one actual model in the current state;
determine a weight of an output of the reference model for the provided input and a weight of an output of the at least one actual model in the current state; and
compare the current state of the at least one actual model with the at least one state of the reference model based on the weight of the output of the reference model and the weight of the output of the at least one actual model in the current state.

13. The electronic device (100) as claimed in claim 9, wherein modifying the current state of the at least one actual model to emulate the target state to be achieved by the at least one actual model minimizes an error between the current state of the at least one actual model and the target state to be achieved by the at least one actual model.

14. The electronic device (100) as claimed in claim 9, wherein the emulation management controller (180) is further configured to:
determine an improvement in at least one set of parameters of a plurality of set of parameters associated with an actual model of a plurality of actual models based on reward, wherein the reward is determined using a reinforcement learning technique, wherein the actual model is an alternate model newly introduced and the plurality of models are existing models; and
emulate the at least one set of parameters of the plurality of set of parameters associated with remaining actual models of the plurality of actual models based on the improvement in the at least one set of parameters of the actual model.

15. The electronic device (100) as claimed in claim 14, wherein the at least one set of parameters of the plurality of set of parameters is shared between the plurality of actual models by a publish-subscribe (Pub-Sub) parameter sharing service and wherein the plurality of actual models is a set of parallel models.

16. The electronic device (100) as claimed in claim 9, wherein the target state of the at least one actual model is emulated to the current state of the at least one actual model by copying the plurality of set of parameters of a neural network of the reference model.
